(19) United States
(12) Patent Application Publication
(10) Pub. No.: US 2014/0006939 A1
(43) Pub. Date: Jan. 2, 2014

(54) DISPLAY METHOD FOR CORRELATED IMAGES AND TEXTS AND ELECTRICAL BOOK SYSTEM UTLIZING THE SAME

(71) Applicant: Shun-Fu Technology Corp., Taipei City (TW)

(72) Inventor: Yung-Sheng HUANG, Taipei City (TW)

(21) Appl. No.: 13/922,866

(22) Filed: Jun. 20, 2013

(30) Foreign Application Priority Data
Jun. 27, 2012 (TW) 101122953

(51) Int. Cl. G06F 17/24

(52) U.S. Cl. CPC G06F 17/24
USPC 715/256

(57) ABSTRACT

A display method includes the following steps: establishing a database of general information; and calling out general information corresponding to texts on a page which is read and displaying the general information on the page controllably to coexist with the texts simultaneously.

### BACKGROUND OF THE INVENTION

1. Field of the Invention

The invention relates to an information display method, and in particular relates to a display method for correlated images and texts.

2. Description of the Related Art

Taiwan patent No. 1386844 discloses a display method for information including correlated texts, wherein a single page is displayed for a reader when information is accessed by an electronic device. A part of information on the previous page and the next page can be quickly previewed when the reader watches the upper margin and the lower margin of the current page, therefore the reader can determine to read which information.

The display method disclosed in the described Taiwan patent reduces visual fatigue caused by scrolling pages up and down. When an electronic book includes texts, images, forms, mathematical equation, chemical equation and notes and the texts and other information corresponding to the texts do not on the same page, the reader may need to scroll pages up and down to find the information corresponding to the texts. This may cause visual fatigue.

### SUMMARY OF THE INVENTION

The invention provides a display method for correlated texts and images in an electrical book. The display method includes the following steps: establishing a database of general information; and calling out general information corresponding to texts on a page which is read and displaying the general information on the page controllably to coexist with the texts simultaneously. In this way, the reader can read general information corresponding to the texts and need not to scroll pages up and down.

Preferably, the general information and the texts coexist by fixing or floating on the page.

Preferably, the general information and all texts on the current page are displayed simultaneously.

Preferably, the coexistence is stared or ended by corresponding devices.

Preferably, the corresponding devices comprises a function key or a scroller of a mouse, function keys of a keyboard, a touch screen or a sensor.

Preferably, the general information is enlarged or narrowed by the corresponding devices.

Preferably, the general information comprises texts, images, forms, mathematical equations or chemical equations.

Preferably, the general information comprises images, forms, notes or references.

Preferably, when the general information is inserted into the page, texts of the page are arranged again automatically to dodge the inserted general information.

The invention provides an electrical book utilizing the described display method for correlated texts and images.

### BRIEF DESCRIPTION OF THE DRAWINGS

The invention can be fully understood by reading the subsequent detailed description and examples with references made to the accompanying drawings, wherein:

FIG. 1 is a flow chart of an electrical book system of the invention.

### DETAILED DESCRIPTION OF THE INVENTION

The electrical book program establishes a data base of general information of a electrical file including images, forms, chemical equations, mathematical equations, references and notes.

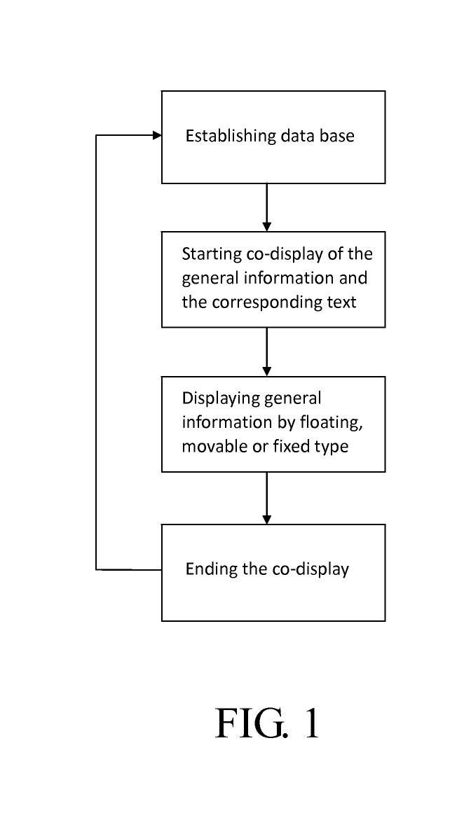

For example,

| Image | | | Form | | | Note | | | Reference | | | Euqation |
|---|---|---|---|---|---|---|---|---|---|---|---|---|
| FIG. 1 | FIG. 2 | FIG. 3 | Form 1 | Form 2 | Form 3 | Note 1 | Note 2 | Note 3 | Reference 1 | Reference 2 | Reference 3 | X + Y + Z = T(A-1) |
| Name A | Name B | Name C | Name A | Name B | Name C | | | | | | | |
| page | page | page | page | page | page | | | | | | | |

When a page of an article of the electrical file mentions “FIG. 1”, the text “FIG. 1” is clicked or selected by a mouse, a touch screen or image sensor to display the general information corresponding to “FIG. 1” on the current page and coexisting with the text “FIG. 1”.

The position of general information corresponding to FIG. 1 is possibly floating or moving with the reading position without blocking the articles not read yet.

The general information corresponding to the text “FIG. 1” is possibly fixed on a certain position on the current page.

The general information corresponding to the text “FIG. 1” is possibly enlarged or narrowed by a function key or a scroller of a mouse, function keys of a keyboard, a touch screen or an image sensor.

When the general information corresponding to the text “FIG. 1” is not needed, the coexistence of the general information and the text “FIG. 1” is ended by using a function key of a mouse, such as the right button of a mouse or other buttons, clicking a specific position of the article, using combination of other function or method, touching a specific position on a touch screen, using other function key of a keyboard or sensing a gesture by an image sensor.

In addition to images, forms, notes, references or equation cane be displayed by the described method.

Images and forms are displayed as image format, but notes and references are displayed as text format.

Images and forms can be enlarged or narrowed, but notes, references or equations cannot be enlarged or narrowed.

The text format is a text box to display notes, references and equations. The texts in the text box are automatically arranged to have a highly concentrated layout and thus displayed by a minimal text box.

Notes, references and equations are displayed by the text format. The text size is enlarged or reduced by pushing a function button of a mouse such as the scroller, touching a specific region of a touch screen, sliding on a touch screen such as horizontally sliding, vertically sliding or sliding in other directions.

While the invention has been described by way of example and in terms of preferred embodiments, it is to be understood that the invention is not limited thereto. To the contrary, it is intended to cover various modification and similar arrangement (as would be apparent to those skilled in the art). Therefore, the scope of the appended claims should be accorded the broadest interpretation so as to encompass all such modification and similar arrangements.

What the invention claimed is:

1. A display method for correlated images and texts comprising the following steps:
establishing a database of general information; and
calling out general information corresponding to texts on a page which is read and displaying the general information on the page controllably to coexist with the texts simultaneously.

2. The display method as claimed in claim 1, wherein the general information and the texts coexist by fixing or floating on the page.

3. The display method as claimed in claim 2, wherein the general information and all texts on the page are displayed simultaneously.

4. The display method as claimed in claim 3, wherein the coexistence of the general information and the texts is stared or ended by corresponding devices.

5. The display method as claimed in claim 4, wherein the corresponding devices comprises a function button or a scroller of a mouse, function keys of a keyboard, a touch screen or an image sensor.

6. The display method as claimed in claim 5, wherein the general information is enlarged or narrowed by the corresponding devices.

7. The display method as claimed in claim 1, wherein the general information comprises texts, images, forms, mathematical equations or chemical equations.

8. The display method as claimed in claim 2, wherein the general information comprises texts, images, forms, mathematical equations or chemical equations.

9. The display method as claimed in claim 3, wherein the general information comprises texts, images, forms, mathematical equations or chemical equations.

10. The display method as claimed in claim 4, wherein the general information comprises texts, images, forms, mathematical equations or chemical equations.

11. The display method as claimed in claim 5, wherein the general information comprises texts, images, forms, mathematical equations or chemical equations.

12. The display method as claimed in claim 6, wherein the general information comprises texts, images, forms, mathematical equations or chemical equations.

13. The display method as claimed in claim 1, wherein the general information comprises images, forms, notes or references.

14. The display method as claimed in claim 2, wherein the general information comprises images, forms, notes or references.

15. The display method as claimed in claim 3, wherein the general information comprises images, forms, notes or references.

16. The display method as claimed in claim 4, wherein the general information comprises images, forms, notes or references.

17. The display method as claimed in claim 5, wherein the general information comprises images, forms, notes or references.

18. The display method as claimed in claim 1, wherein when the general information is inserted into the page, texts of the page are arranged again automatically to dodge the inserted general information.

19. The display method as claimed in claim 2, wherein when the general information is inserted into the page, texts of the page are arranged again automatically to dodge the inserted general information.

20. The display method as claimed in claim 3, wherein when the general information is inserted into the page, texts of the page are arranged again automatically to dodge the inserted general information.

21. The display method as claimed in claim 4, wherein when the general information is inserted into the page, texts of the page are arranged again automatically to dodge the inserted general information.

22. The display method as claimed in claim 5, wherein when the general information is inserted into the page, texts of the page are arranged again automatically to dodge the inserted general information.
